(19) United States
(12) Patent Application Publication
(10) Pub. No.: US 2013/0275236 A1
(43) Pub. Date: Oct. 17, 2013

(54) Fresh Departments Management System

(71) Applicant: SEALED AIR CORPORATION (US), Elmwood Park, NJ (US)

(72) Inventors: John Koke, Duncan, SC (US); Charles Sperry, Florence, MA (US); Vincent Piucci, Oakham, MA (US); Stephen Smith, Williamsburg, MA (US); Daniel Healey, Chelmsford, MA (US)

(21) Appl. No.: 13/859,129

(22) Filed: Apr. 9, 2013

Related U.S. Application Data
(60) Provisional application No. 61/623,799, filed on Apr. 13, 2012.

(51) Int. Cl. G06Q 50/12

(52) U.S. Cl. CPC G06Q 50/12; G06Q 10/06315
USPC 705/15

(57) ABSTRACT

The system comprises a central processing module that is configured to interconnect the fresh departments and operational functions. These tasks can include facilitated order fulfillment, inventory and accounting functions, sanitation, maintenance, traceability and others. This is a system that integrates various sub-systems within the fresh departments, as well as integrating the fresh departments together. The system may also utilize a plurality of slicing machines that communicate with the centralized processing unit. The software modules resident in the processing unit receive inputs that represent customer orders, and dispatch these orders to the plurality of slicing machines. The slicing machines are in communication with the software modules such that the modules are aware of the food product that is currently placed on the slicer. In this way, the software modules are able to direct specific orders to a particular slicing machine, minimizing human interaction and customer wait time.

This application claims priority of U.S. Provisional Patent Application Ser. No. 61/623,799, filed Apr. 13, 2012, the disclosure of which is incorporated herein by reference in its entirety.

### BACKGROUND OF THE INVENTION

In today's supermarkets, the majority of deli orders are made and fulfilled manually. Often, a customer enters a supermarket and proceeds to the deli counter. The customer generally obtains a numbered ticket from a dispenser and then waits their turn in the queue. Once their number reaches the top of the queue, the deli employee calls their number, and the customer places their order and then waits for it to be prepared. Often, when the queue is lengthy, one may take a number and start shopping, hoping to return back to the deli at a time close to when their number will be called. Unfortunately, this is often an inexact practice. Often, customers return to the deli counter too soon, when there is still significant wait time, or too late, after their number has already been called.

In an effort to reduce these known issues, many supermarkets have incorporated electronic kiosks. At this kiosk, the customer can enter their entire order and receive a number. The customer is then free to continue their shopping, knowing that the deli has the information needed to complete their order. At a later time, the customer returns to the deli counter and picks up their completed order. Technologies exist to allow orders to be placed remotely, using a mobile device or an internet connection, or by telephone.

While the use of kiosks eliminates the need for the customer to wait in line, there are numerous lingering issues. For example, the integration of these kiosk orders with those of waiting customers can be problematic. If waiting customers believe that previously submitted kiosk orders are being given priority over them, the waiting customer may view this treatment as unfair, and may vocalize their displeasure. To counteract this behavior, the deli employees may choose to serve the waiting customers first, delaying the submitted kiosk orders. However, if a customer, who had previously submitted an order and has since finished shopping, returns to the deli counter to find that their order has not been processed, that customer may also become upset.

Another problem is the current delicatessen model, which has existed almost unchanged for years. Customers place orders, whether directly with an associate or via a kiosk, and slicing machines are manually loaded with the desired food product and an associate slices the food product, weighs the food product, bags and labels the food product before passing it to the customer. This arduous process involves the sequential steps of retrieving the food product, unwrapping the food product, placing it on the slicer, slicing it, stacking the food product, weighing it, packaging the food product, placing a label and price on the packaging, handing it to the customer, rewrapping the remaining food product and returning it to its storage location. This time consuming process is one of the fundamental issues associated with delicatessen queuing and affects throughput. To address this, many supermarkets attempt to staff the delicatessen counter to handle the time periods of expected higher demand.

However, many supermarkets have limited space and a limited number of slicing machines. Therefore, even if there were a large number of associates, the maximum throughput would still be limited by the number of slicers and the amount of time required to prepare each item on a slicer.

Often, the delicatessen department includes a section of prepared foods. These can include salads (potato, egg, bean, etc.) as well as other prepared items ranging from stuffed peppers to rotisserie roasted chickens. Some delis include pre-made sandwiches and other ready-to-eat meals. In some cases, sandwiches can be made to order, and some supermarkets even include a pizzeria. In some supermarkets, the pizzeria and/or sandwich shop is in a different physical location than the deli, and may be managed by a different manager.

In addition to the deli, pizza and sandwich shops, other departments within the fresh perimeter of the store must contend with custom orders. These departments can include the meat department, seafood, bakery and others. All of these departments plus the produce department make up the fresh perimeter of the store. The fresh departments contain the food items that have a short shelf life and must be managed, not only for sales and inventory, but also for spoilage, loss and sanitation. Even fresh departments such as produce, that do not normally accept custom orders, can benefit from an improved management system.

Currently, in most supermarkets, the various departments within the fresh perimeter may be managed independently from each other, with no central method to accept, fulfill and deliver orders to customers. Additionally, there may be no provisions to automatically link the departments together for purposes of accounting, inventory, sanitation, shrink control and other necessary functions.

Current systems fail to adequately address these issues. Therefore, a fresh department management system that addresses these and other shortcomings would be beneficial.

### SUMMARY OF INVENTION

The problems of the prior art are addressed by the fresh management system of the present disclosure. The system comprises a central processing module that is configured to interconnect the fresh departments and operational functions, and can communicate with sub-modules that perform various tasks. These tasks can include facilitated order fulfillment, inventory and accounting functions, sanitation, maintenance, traceability and others. This is a system that integrates various sub-systems within the fresh departments, as well as integrating the fresh departments together.

The system may also utilize a plurality of slicing machines that communicate with the centralized processing unit. The software modules resident in the processing unit receive inputs that represent customer orders, and dispatch these orders to the plurality of slicing machines. The slicing machines are in communication with the software modules such that the modules are aware of the food product that is currently placed on the slicer. In this way, the software modules are able to direct specific orders to a particular slicing machine, minimizing human interaction and customer wait time.

Advantages of this system include labor savings through increased efficiencies and improved profitability through inventory, pricing and loss control. The reduction of labor may be used to lower the overall cost of operations, and may also allow the associates to spend more of their time assisting customers. This system also enhances the customer's shopping experience. Additional benefits include improved compliance with sanitation and maintenance protocols, enhanced traceability of food items, as well as management alerts and reporting capability. Also, the linked, automated systems decrease the amount of manual input into the system, reducing human errors.

### BRIEF DESCRIPTION OF DRAWINGS

FIG. 1 is a schematic showing a representative embodiment of a slicing system for use with the present invention.

FIG. 2 is a schematic showing a representative embodiment of the software modules of the present invention.

FIG. 3 is a flowchart of the ordering process.

FIG. 4 is a flowchart of the food holder usage cycle.

FIG. 5 is a schematic showing representative functions of the present invention.

FIG. 6 is a representative illustration of an order board according to one embodiment.

FIG. 7 is a representative illustration of an order board according to a second embodiment.

### DETAILED DESCRIPTION OF THE INVENTION

As described above, the systems used for deli counters in most supermarkets, sandwich shops and commissaries have shortcomings. For the purposes of this disclosure, an “order” is defined as a single item or multiple items that are requested by the consumer or customer. An “item” is a request for a single food product, including its slice thickness, packaging preferences, etc. In the example of the deli, an example of a single item could be one half pound of roast beef, sliced medium in thickness. An example of an order consisting of multiple items may be a half pound of roast beef plus a quarter pound of honey ham plus a pound of American cheese. In addition, a customer may request special packaging, such as shingled arrangement of slices or separator sheets. “Fulfillment”, as defined in this disclosure, may comprise selecting each of the food products associated with an order, preparing or portioning, slicing, weighing, wrapping, labeling and any other functions necessary to prepare an order for pick up by, or delivery to, the customer. “Fulfillment” may include manual preparation as is commonly done today, an automated fulfillment system, or a combination of both.

In addition to the deli, the fresh perimeter of a store may include other departments. The prepared foods department is often located within the deli and staffed by deli associates. This department prepares and sells foods such as salads, sandwiches and other pre-made items. The bakery, seafood, produce and meat departments also sell perishable foods. Some supermarkets have a pizzeria, and some have a custom sandwich shop. Others have a separate department that prepares platters to order. These departments each prepare custom orders. Although the present invention described herein has been focused mostly on the deli, most of the fulfillment and other management functions can easily be adapted to the other fresh departments.

One advantage of the management system of the current invention is the customer's ability to place the complete order at one time, and then continue shopping while the order is being prepared. This is substantially more time and labor efficient than the traditional method of waiting in line at the deli counter until an associate is available, then ordering one item, waiting for its preparation, ordering the next item, and repeating this process until the entire order is fulfilled. Another advantage is a reduction in the number of deli associates required to staff the counter, while still realizing a decrease in average customer wait time.

Another advantage of this system is that all items in a customer's order are linked together and to the customer, whether they are automatically or manually fulfilled. At any point during the fulfillment process, the customer may add to or modify an item in the order through any of the available ordering means.

Alternatively, ordering may be accomplished in a one-at-a-time manner as is done today. For example, a single item is ordered, it is prepared by the associate, and when the item is delivered to the customer, the customer is asked whether they would like an additional item, and so on until the order is complete.

Regardless of ordering method, fulfillment may be carried out in multiple ways. In one embodiment, the associate that receives the order also prepares and delivers the order, and may complete the customer's entire order by themselves. In another embodiment, as orders are being taken, associates will begin servicing the orders as they are being placed. Multiple associates may be working on fulfilling various items within a single customer order. Associates may be chosen for an action based on task, e.g. an associate may be responsible for wrapping and labeling of items; or associates may be chosen based on their availability.

With the management system of the current invention, orders can be received through a variety of sources. These include but are not limited to:
Orders placed at the deli counter in the same manner as is done today;
Orders placed with sales associates located in front of the deli counter, or in other locations within the store;
Orders placed through an automated kiosk that is located within the store;
Orders placed from a remote location or within the store using an Internet connection;
Orders placed remotely or within the store using applications available on mobile devices, such as smart phones, PDAs, etc.;
Orders placed over the telephone; and
Immediate sample request order by associate working with customer (which may be considered a high priority).
   All of these aforementioned methods and technologies are commercially available and the ability to place an order using any of these technologies is known to those skilled in the art. As new communication technologies emerge, the system can be adapted to accept orders from them as well.

The present invention describes a management system in which orders are input through a variety of mechanisms. Items in those orders can be dispatched to a plurality of slicing machines. These slicers are connected to a processing unit, such as via a computer network. In addition, the slicers have the ability to know or determine the food product that is placed on the slicing machine. This may be accomplished using a bar code scanner, an RFID tag, a keypad, or any other appropriate input method. Items in the order may also be dispatched to an associate who manually prepares the item. The system of this invention creates a seamless integration of automated and manual tasks. It is important that all components of the present invention are connected and can communicate with each other. This can be accomplished by any conventional networking technologies consisting of wired, wireless, or a combination of both methods.

Thus, the processing unit has knowledge of the incoming orders, as well as the food products that are already loaded on the slicing machines. If an order contains at least one food product that is already loaded, the software module resident on the processing unit may dispatch that item to the appropriate slicer. The information passed to the slicing machine may include the identity of the food product, the amount of the food product to be sliced, the thickness of each slice, and the order number, so that this item can be joined back with the rest of the items in the order before delivery to the customer. Once completed, the slicer may notify the software module that the item is completed, thereby allowing the software module to dispatch another item to it. In some embodiments, the slicer may have a dedicated labeler and may print out a label when the item is completed. In other embodiments, a central labeler may be used, which prints out a label along with an identifier of the slicer with which the label is associated. In some other embodiments, the slicing machines have a memory device associated with them, such that the software module may dispatch multiple items simultaneously to the slicing device, which processes them in order.

While the present embodiment is focused on the use of unattended slicers to simplify and maximize production, this concept may be combined with other time saving concepts. For example, in some embodiments, if a customer is going to wait for their order, that order may be moved toward the top of the queue, generally on a first come first served basis of customers that are waiting. Orders with later fulfillment times will be queued after these orders.

With this information, the queue can be dynamically monitored and rearranged to optimize order delivery.

The present system may also be used to manage the inventory of the fresh department. For example, the system may be made aware of the amount of each food product currently resident in the deli (i.e. the initial inventory). As orders are placed and serviced, the system may estimate the total remaining inventory based on the amount of each food product consumed by each order. As the current inventory of one or more food products drops below a predetermined threshold, the system may notify the staff of the need to replenish that food product. Thus, rather than manually reviewing the inventory periodically to determine ordering needs, the system can be queried and will provide an estimate, based on actual orders, of the inventory. In other embodiments, the system may generate an inventory report periodically. It can also automatically generate stock orders. In some embodiments, the slicers have the capacity to actively weigh the remaining food product. Rather than estimate the remaining product, the actual weight is known. This adds to the accuracy of the inventory system. In other words, the actual weight of food products associated with an automated slicing machine may be known, because of scales coupled to the slicing machines. This allows the weight of partially consumed food items to be added to unused food items to generate a more accurate, real time measure of inventory.

As an example, suppose that salami from a particular supplier is delivered in 3-pound sticks. Initially, the system is made aware that the deli currently has 5 sticks of that food product. As customers place orders for that particular brand, the system deducts the weight of each order from the total amount of salami remaining. As that total amount of salami in the deli drops below a particular threshold, the system can notify staff. In another embodiment, the system can be queried at the end of the week (or any other time) and generate a report on the current inventory. This also allows the system to recognize when the stick, currently loaded on a slicing machine, is nearly consumed. Once this determination has been made, the system can notify the deli associate to prepare another salami stick to be ready to be loaded onto the slicer. As stated above, in another embodiment, the system may realize that 4 sticks have not been used, while one is installed on an automated slicing apparatus with weighing capability. In this case, the remaining weight of the stick that is in use can be ascertained from the automated slicing apparatus and reported with the 4 unused sticks.

In some embodiments, the system can be used to analyze buying patterns or trends. For example, the system can readily compute the daily or weekly consumption of a particular food product. By comparing the consumption amount from one week to another, one can determine the effectiveness of a sale or other promotion. The system may also identify changes in buying behavior. For example, the system may determine that consumption of deli meats decreases in the summer (since children are not in school), based on orders placed over a certain period of time. Based on this, it may suggest a lower replenishment quantity of these food products than may be used at other times of the year.

In addition, the system can be used as a predictive tool. For example, since the system has information about every order that is placed, as well as the day, date and time each order is placed, it may make observations about past buying patterns. Based on this, it may be used to make predictions about future buying patterns. For example, the system may note a trend whereby more orders are placed between 3 and 4 PM in the afternoon. It may further note that roast beef and turkey are often ordered during this time period. In response to this observation, the system may proactively request these food products be placed on one or more slicing machines. This way, when the deli counter gets busy, as expected, roast beef and turkey are already ready for use by the slicing machines, and do not need to be loaded by the associate. In some embodiments, the system may request that the same food product, such as roast beef, be placed on multiple slicing machines if the demand is expected to be great. This predictive function can also analyze trends based on time of day, day of the week, month of the year, or any other function of time. In other words, the system may note that Monday is an exceptionally busy day, while Thursday is exceptionally light. Based on this, the system may proactively request food products, such as roast beef and turkey, on Mondays, but not on Thursday. Similar analysis can be done for month of year, and the system can anticipate demand near a holiday or other occasion.

In addition, the system may note that demand for certain food products is less than anticipated. In this case, the system may request that a food product be removed from the slicing machine and replaced with a more popular food product.

Another use for the forecasting capability is in the preparation of “Grab and Go” products. These are pre-packaged food items consisting of some of the more common deli meats and cheeses, salads, etc., packaged in popular sizes that customers can take from a display case without the need to make a special order from the deli. The system can use forecasting based on sales history, time of day, etc. In some embodiments, a sensing device may be used to monitor the Grab and Go display case and initiate replenishment orders based on a forecast and real time inventory in the case. These sensors can be weight or vision systems, or any other convenient technology known in the art. In other embodiments, the delicatessen slicing system is in communication with the central sales system. In this way, the delicatessen slicing system may be able to determine the need for more pre-packaged food items, based on monitoring the sales of the previously sliced pre-packaged food items. In other embodiments, other mechanisms may be used to monitor the current inventory of previously sliced pre-packaged food items. These mechanisms may be in communication with the system, thereby allowing the system to determine, automatically, when more pre-packaged food items need to be sliced.

Thus, the implementation of the “Grab and Go” products can be performed in several ways. In one embodiment, the system receives actual feedback regarding consumption of previously sliced pre-packaged food items and slices additional pre-packaged food items based on this actual feedback. Actual consumption data may be calculated based on sales, or based on visual or other changes in the display case that contains the Grab and Go products. In some cases, waste (i.e. pre-packaged food items which were not sold within a predetermined time period) is also made available to the system, as this may not require replenishment. In other embodiments, the system uses historical or other data to estimate the forecast, as described above, for pre-packaged food items, and initiates slicing based on this forecast.

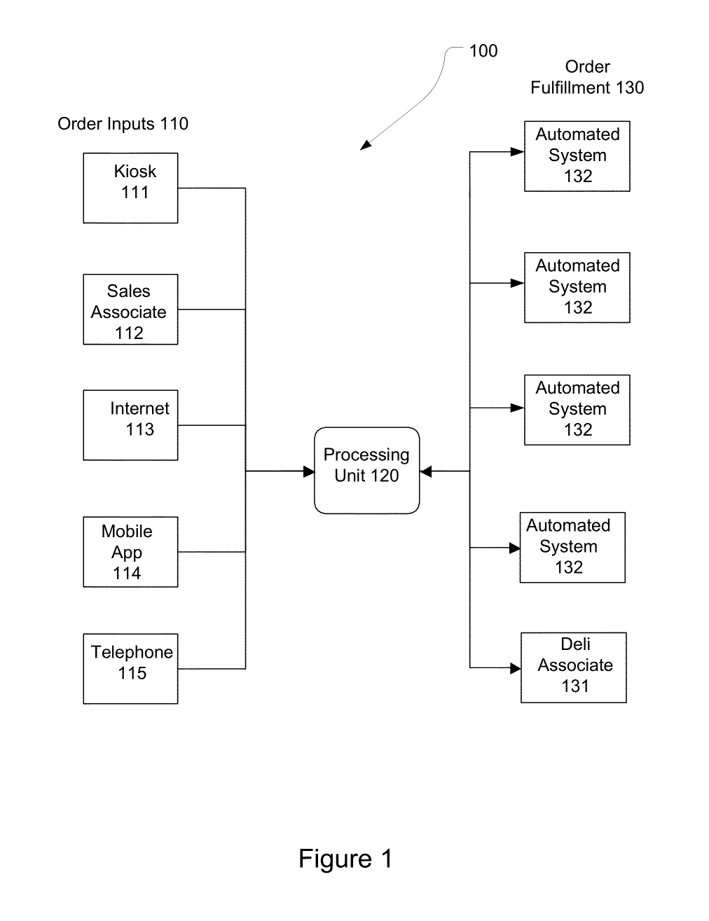

FIG. 1 shows a representative schematic flow chart for the delicatessen slicing system 100. On the left side of the chart are examples of the order inputs 110. A customer inside the store may order using an in-store kiosk 111, or may talk with a sales associate 112, as is done currently. Customers inside or outside of the store may order using the internet 113, a mobile device application 114, or call on a traditional telephone 115. Other input devices include smart phones, tablets, touch screen devices, and keyboards. As new communication technologies are developed, the system can be adapted to accept orders using them.

While the example in FIG. 1 illustrates a deli department function, the ordering system may accept orders for other fresh departments, such as seafood, bakery, pizza shop, etc. The system may forward the orders to those departments for fulfillment using any suitable method. Each of these departments can have their own fulfillment systems, as does the deli. The system may also coordinate the delivery of these items to the customer using any of the delivery methods described herein. In this manner, the system of the current invention can link all of the fresh departments together and coordinate not only fulfillment functions, but all the additional functions as described for the deli department.

When the order is placed, certain information is entered into the system 100. The order entry data may include a number of items, where each item is a desired food product and quantity of that food product. This quantity may be expressed in units of weight, number of slices, caloric content, or other dietary measures, such as Weight Watcher points. The orders are then entered into the processing unit 120. The system may also communicate with electronic personal health tracking devices such as, Fitbit, Nike Fuel Band, etc.

For example, in some embodiments, the processing unit 120 may be aware of the caloric, fat, and protein content of a food product per unit weight. Similarly, it may be aware of the Weight Watcher points per unit weight of the food product. Based on a desired slice thickness, it is then possible to determine this caloric information or Weight Watcher point information for a slice of the food product. With the automated slicer, the system knows the total weight and number of slices, and can calculate the average per slice. This information may be printed on the label if desired. In other embodiments, the slice thickness may be varied such that each slice contains a desired number of calories.

In other embodiments, orders may be placed by way of recipe. For example, certain configurations may be defined, which then can be used to order. As an example, an Italian sandwich may be defined as a specific number of slices of various meats and cheeses. An order for 6 Italian sandwiches would be translated into a set of items in an order, where each item represented a number of slices of a particular food product used to create the Italian sandwich. Other similar methods of defining orders may also be used.

The processing unit 120 maintains a queue of outstanding orders. In some embodiments, this is simply a “first come, first served” queue, or FIFO (first in first out). In other embodiments, the processing unit 120 may rearrange orders in the queue to maximize machine efficiency or minimize customer wait time.

In any scenario, the order at the top of the queue is then submitted to the order fulfillment function 130. The order fulfillment function preferably consists of a plurality of automated slicing machines 132, each in communication with the processing unit 120, such as via a computer network, which may be wired (such as Ethernet), or wireless (such as WiFi, Bluetooth, etc.). Each of these slicing machines 132 may be automatically detected by the processing unit 120, such as via a mechanism such as Plug ‘N’ Play, or a similar automatic enumeration technique. In other words, when a new slicing machine 132 is added to the system, it announces its presence to the central processing unit 120, and is thereafter available for use.

In addition, the slicing machine 132 may have an input means, such as a RFID reader, bar code scanner, keypad, optical scanner, or other apparatus, including manual input by an associate, to allow it to determine the food product that is placed on its platform. In some embodiments, in addition to identifying the type of food product, the input system allows for recognition of a particular food product. In other words, in addition to identifying the brand and type of a food product, such as a stick of salami, the system can identify the particular salami stick. This allows the slicing machine 132 or the central processing unit 120 to track the usage of each individual food product, thereby knowing when that food product is nearly completely consumed, triggering the system to notify the deli associate to replenish the preloaded food product.

As stated above, the slicing machine 132 informs the processing unit 120 of what food product is currently placed on the machine 132. In this way, the processing unit 120 can send orders to the specific slicing machine 132 that currently has the desired food product loaded. In other embodiments, the system informs the associate that a particular food product should be loaded onto a specific slicer. Using this method, the slicer does not need to inform the system as to what product is loaded onto it, since the system is aware of this pre-determined slicer/product relationship.

It is envisioned that multiple slicing machines 132 are each preloaded with the most popular food products, allowing automatic fulfillment of most deli orders. In the event that a desired food product is not preloaded on any of the slicing machines 132, the processing unit 120 notifies a deli associate 131. The deli associate can, upon notification, either replace one of the preloaded food products with the desired food product, or alternatively, slice the desired food product on a traditional manual slicer. It is envisioned that a fully automatic system could be used. This system could use robotics, conveyors or other means to select and load the food items from refrigerated storage onto the slicers. This management system could be adapted to also control this.

It should be noted that, while FIG. 1 shows a single processing unit, the invention is not so limited. For example, a first processing unit may be used to communicate between the customer inputs 110 and the order fulfillment function 130. Processing units may also exist within the slicing machines 132 which allow it to recognize food items, maintain a queue of orders to be fulfilled, and perform other functions.

As described above, the management system is controlled by a processing unit 120. This unit 120 may be a stand-alone computer, such as a personal computer (PC) or specially designed computing device. In other embodiments, the processing unit 120 is a part of the facility's central computer system. In other embodiments, the processing unit 120 may be remote or part of a computing cloud.

The processing unit 120 includes a processor, an input device capable of receiving orders using one or more methods described above. In addition, the processing unit has a memory element, which may be volatile or non-volatile. Instructions that can be executed by the processor are stored in the memory element. These instructions allow the processor to create and maintain the queue structure described herein. In addition, these instructions allow the processor to estimate fulfillment time of a particular order, and may include notification means. The instructions executed by the processor may be written in any suitable computer language. Furthermore, a portion of the memory element may be used for volatile information. For example, the actual queue structure and entry form data may be stored in the same memory element as the instructions. In other embodiments, the queue structure and entry form data is kept in a separate memory element, also accessible by the processor. The processing unit can reside in a corporate computer, such as in a corporate data center, on a remote server, on a local PC, or on a combination of these and any other available technologies.

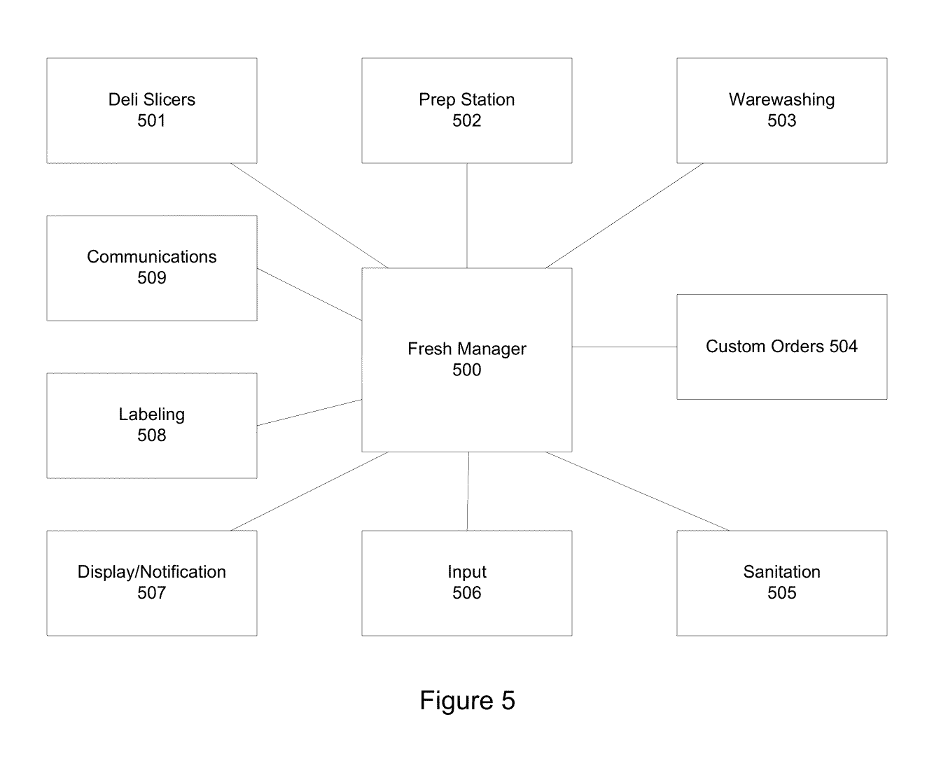

FIG. 5 shows a representative embodiment of the functions controlled by the Fresh Manager system 500. Included in these functions are operation of the deli slicers 501, either automated or manual slicers (while only deli slicers are discussed, this may apply to any other automatic or manual apparatus); the prep station 502 where food items are prepared for slicing; a warewasher 503 that cleans and sanitizes food containing and processing items; custom orders 504 for departments that include deli, prepared foods, bakery, seafood, meat, pizza and sandwich shop, and produce; sanitation protocols 505 in all the above departments; input devices 506 for ordering; display and notification 507 for both customers and associates; labeling 508 for customer orders and associate instructions; and communication 509, with all system components, within the department, between departments, between individual stores, and between stores and corporate.

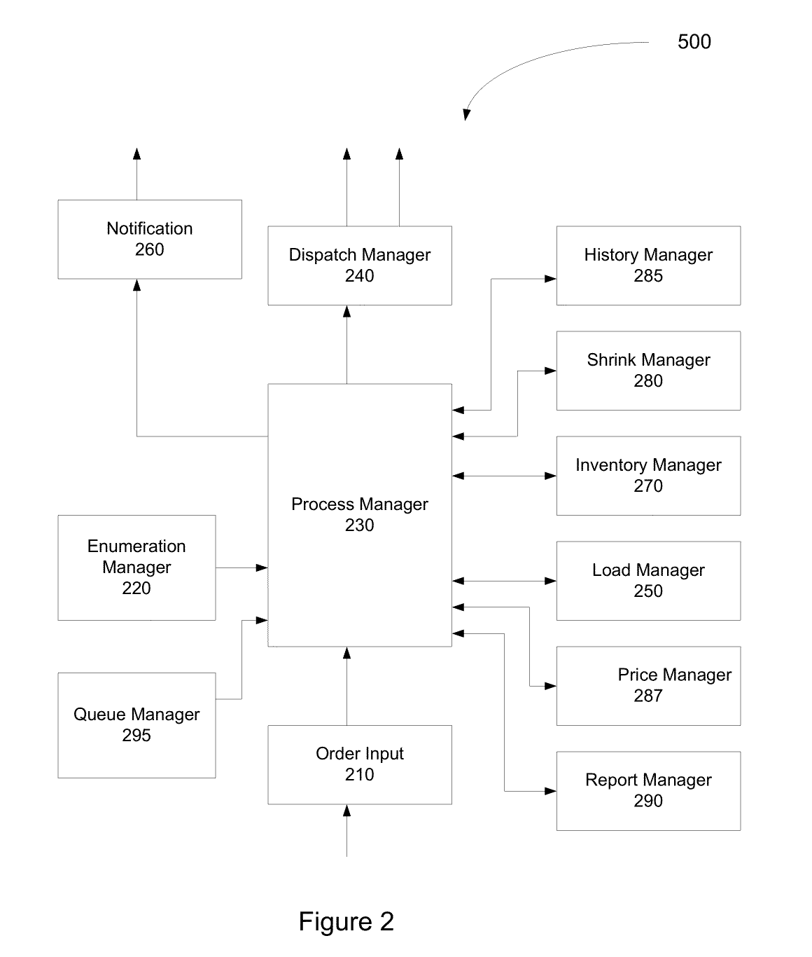

FIG. 2 shows one representative embodiment of the software modules used in the processing unit of the fresh manager 500. Other embodiments are also within the scope of the invention and FIG. 2 only represents one possible embodiment. These modules may be resident in the memory element described above. Each of these module comprises instructions which, when executed by the processing unit 120, perform the functions discussed herein.

The process manager 230 is the processing module, or operating system, of the Fresh Manager system 500. This module contains all of the basic operating instructions, and communicates with all of the other modules.

Order information is accepted by the Order Input module 210. This module accepts input from any of the sources shown in FIG. 1. This module then creates an order record, which includes the order information, order identification number, customer information, and optionally, customer loyalty information, and an indication of the order's priority. For example, if the customer enters the order via a kiosk and continues to shop, that order may have a low priority. In other embodiments, if the customer waits at the counter, that order receives a higher priority.

In some embodiments, the priority information is then used by the queue manager 295 to properly insert the new order into the queue. In other embodiments, orders are placed in the queue in the order that they were received.

Orders inserted in the queue may be single or double linked, as deemed appropriate by the implementer. The queue manager 295 finds the position in the queue where the new order should be placed, based on priority. Other parameters, such as customer loyalty information, may be used to determine the position of the new order in the queue. In some embodiments, more than one queue may be used, such as an Order and Item queue. The queue manager 295 is intended to manage all such queues. It should be noted that the software modules used to manage each queue may be separate, communicating relevant information between them. In other embodiments, all queues are managed by a single software module.

An enumeration manager 220 is responsible for determining the number of slicing machines 132 attached to the system, as well as the food product loaded on each slicer. Based on this, the process manager 230 is able to determine whether an item in a particular order can be processed automatically, or must require manual intervention.

In a first example, the process manager 230, based on information from the enumeration manager 220, ascertains that at least one slicer 132 is loaded with the food product requested in the order currently being processed. Upon making this determination, the process manager 230 sends this item to the appropriate slicer (as identified by the enumeration manager 220), via the dispatch manager 240. In some embodiments, the dispatch manager 240 communicates with the slicers 132, such that it is aware of their operating state (busy or idle). In some embodiments, the dispatch manager 240 only sends one item to a particular slicer 132, and holds any other items destined for that slicer until it sees that the slicer's status is now idle. In other embodiments, the slicers 132 each have an internal memory such that they may hold a plurality of items in a local queue, processing each in the order received. In yet another embodiment, the process manager 230 stops until the slicer required by the current order is idle.

In a second example, where the desired food product is not preloaded on one of the slicers 132, as determined by the enumeration manager 220, the process manager 230 uses the notification module 260 to make the deli associate aware of the situation. The deli associate may then be notified to prepare this order manually, using a conventional slicing machine, or to replace one of the pre-loaded food products with the requested food product. The fresh manager system integrates the automatic and manual functions in a seamless and efficient manner.

In some embodiments the process manager 220 contains a database with item-specific information that can be used to adjust operating parameters of the automatic slicers, such as feed rate, blade speed, etc. The database may also contain information such as recipes, so that a customer may place an order, for example meat and cheese for Italian sandwiches and the process manager can determine the correct quantities of each meat and cheese in that particular sandwich.

The notification module 260 may also issue management alerts. These alerts can be tailored as desired. They can be delivered only to certain employees, and can be delivered in a preferential way, such as text, phone, email, print copy, message on display monitor or any other visual or audible method. Some of the possible alerts include equipment malfunction, staffing issues, inventory shortage, maintenance required and other alerts. Notification and other outputs from the system can be via text messaging, email, visual display or other means. In some embodiments, one or more printers is attached to the system and are used to output reports or notifications as required.

In addition, the notification module 260 may perform other functions, such as maintenance alerts. For example, the notification module may allow prompting of necessary staff that normal or preventative maintenance is required; insure that maintenance is complete; receive and send information as required regarding a malfunction, and compile and maintain a maintenance log. This maintenance can include periodic cleaning of manual or automatic slicers or other equipment, replacement of normal wear components, or any other maintenance tasks that are required within any of the departments controlled by the system. Some devices, such as automatic slicers may have on-board diagnostics that can automatically notify the system in case of a malfunction.

The notification module 260 may also be used to inform customers of special pricing, or other events in a real-time manner. This can be done with the use of display monitors, public address systems, smart phone, internet, or any other communication means.

The system can assist the store management by monitoring and assigning associates based on staffing needs. Some of the functions include relocation of staff within the store based on the fluctuating workload; prediction of staffing needs based on historical trends, and maintenance of staffing logs. This information can be relayed via the notification module 260. This allows the ability to link and share the various departments' labor resources. This can increase overall resource efficiency via cross-department labor planning and automatic reassignment of associates as needed on a real-time basis.

In fact, the present invention, and the notification module 260 may be used in a conventional deli having all manual slicers. Rather than sending a signal to a preloaded automatic slicer, it can send a signal to an available deli associate via display monitor, headset, body-worn display device or other means. The associate then selects the appropriate food item, slices, weighs, wraps and labels the order in the conventional manner, then signals the manager that the order is complete. The manager can then send the associate another order.

The system may also have an inventory manager 270. The inventory manager 270 also has visibility to the orders that are being processed by the process manager 230. Therefore, based on these pieces of information, the inventory manager 270 may track the inventory of each food product in the delicatessen. The module 270 may receive inputs from the staff to determine initial inventory levels. The inventory manager 270 may communicate with the process manager 230 as orders are processed so that it can continue to monitor the current inventory level of all food products in the deli. The inventory manager 270 may have the ability to notify staff when the quantity of a particular product drops below a predetermined threshold. In other embodiments, the inventory manager 270 may generate an inventory report, detailing the quantity of each food product. In another embodiment, the report would only identify food products that need to be ordered. The inventory manager 270 may also be used to monitor the real-time inventory levels of all of the fresh departments. It also receives information from other systems that can be used in predictive planning. The system can generate order requests for the purchasing department, and can even automatically generate orders and place them with vendors. The inventory manager 270 can calculate the necessary inventory based on data that includes sales history, shrink vs. inventory levels, predicted sales, etc.

The inventory manager 270 also may manage rotation of stock, insuring that the oldest product is used first. This is possible since it can have a real-time inventory complete with lot numbers and expiration dates. For example, when a food product needs to be replenished, the associate can be notified as to which specific product should be selected, such as Honey baked ham, lot number xxx, expiration date xxx, and may include an identifier of the physical location of the stock item. The associate will identify and select that specific product. The inventory manager may also identify and locate products that have passed their expiration date, and instruct the associate to remove and dispose of the products. This can be done for a product that is on a slicing machine or in a stock location.

As stated earlier, each automated slicer 132 may have input means to identify the particular food product that is loaded on it. Thus, it may also be possible for the inventory manager to maintain a status of each individual food product in the delicatessen. Thus, rather than simply determining how much salami is available, the inventory manager 270 may determine the number of sticks (whether partially consumed or new), and the amount that each of those sticks has been consumed. For example, the inventory manager 270 may determine that the stick of salami that is preloaded on one of the slicers 132 is 70% used; a second stick has been 20% used and a third stick has not yet been opened. This level of detail also allows the inventory manager 270 to inform the process manager 230 when the food product on a particular slicer needs to be replaced.

The system may also have a load manager 250, which monitors the popularity of food products to insure that the most popular food products have been preloaded on the slicers 132. For example, the load manager 250 may monitor incoming orders, via the queue manager 295 and generate a histogram or other representation of usage. This usage profile is then compared to the food products that are actually loaded on the automatic slicers 132. If the load manager 250 finds a discrepancy, a notification may be provided to the deli associate, instructing him as to which food product to unload, and what food product should replace it. The load manager 250 may also use historical or predictive data in making its determinations. For example, past history may show that on a particular day, the buying patterns differ from other days. It may then suggest a modification of the preloaded food products to agree with this buying pattern. The load manager 250 may also use predictive techniques to load the slicers. For example, knowledge of a sale next week may lead the load manager 250 to replace an existing food product with the food product on sale. In addition, knowledge of an upcoming holiday season may also vary the normal buying pattern and require a different loading configuration. With this information, the load manager 250 can set up the slicer configuration at the beginning of the day or other production period, and can then reconfigure in real-time based on dynamically changing patterns. This predictive information may also be used to pre-load certain popular items into product holders so that they are ready to be placed onto a slicer when needed. Additionally, the load manager 250 can use specific food product characteristics to optimize slicing efficiency. For example, some food products are either not well suited to automatic slicing, or are not consumed in high enough volume to warrant loading onto an automatic slicer. These will be directed to a manual slicer rather than be configured onto an automatic slicer.

In addition, the load manager 250 may also generate reports on efficiency, noting what percentage of orders were handled automatically using preloaded food products. It may then also compare this percentage with that which would have been achieved if there were more slicers. For example, the load manager 250 may determine that the percentage of automatic fulfillments would increase by 10% with the addition of one more slicer and increase 15% with the addition of three more slicers. This, again, can work in a conventional deli by analyzing the efficiency and number of associates available.

Various other functions can also be provided by the present invention. For example, there may be a shrink manager 280. The shrink manager 280 has the ability to monitor and help predict and contain losses due to expired or spoiled products, theft, etc., known in the industry as “shrink” losses. The shrink manager 280 can collect information including spoilage, expired products, expiration dates of current products, missing inventory due to theft, etc. and current inventory levels based on automatic or manual inventory counts. Because sampling, i.e., giving a customer a slice of the food product prior to slicing the complete order, may be part of the deli operation, the system can also report exactly how much product was given away as samples. The system can then analyze the data in view of spoilage vs. inventory level, loss due to theft, etc. or other relationships as desired.

This information can be used to report shrink results and, more importantly, assist in improving yield by anticipating loss based on inventory, shelf life, etc., and controlling inventory and pricing to minimize loss. For example, if a large amount of shrink is due to expiry or spoilage, the shrink manager 280 may recommend that the inventory levels for these products be reduced.

The present invention may include a price manager 287. The price manager 287 changes, in real time, product prices to more rapidly sell slow moving items, items nearing expiration, overstocked items, and for seasonal or holiday sales. The price manager 287 receives information from the other system modules in order to determine when to lower a price. The benefits include minimizing waste due to spoilage and expiration, to help sell products that are moving slowly, and to help generate additional sales via promotions. The system includes the ability for individual stores to communicate with corporate systems for real-time pricing updates. The system also has the ability to communicate with and coordinate all systems that are involved when a price changes. These can include communicating with and updating electronic price labels, display monitors or other customer notification devices to display the promotion; point of sale systems such as cash registers; and weigh price label systems for the correct product information.

The present invention may include a history manager 285. The history manager 285 tracks and analyzes historical trends within the fresh departments. Some of the data analyzed by the History Manager includes sales compared to day, date, time of day, even weather; shrink vs. inventory levels; pricing vs. sales and any number of historical interrelations. The results may be used in many ways. Some examples include reporting, sales forecasting, and predictive planning for pre-preparation of food, staffing needs, inventory levels, equipment and maintenance needs and shrink management.

The present invention may include a report manager 290. The report manager 290 gathers information from all the other system modules, then compiles and analyzes the information in order to generate reports. The system can create any type of report desired on a corporate, store or department level. These reports can be used for management, inventory, human resources, maintenance accounting, shrink management, etc. These reports can be printed to a printer, stored in any suitable format or saved as webpages. The system can include a full service terminal or web portal that allows corporate employees, store managers and associates to get instant, real-time information. Information and reports may be queried from the system, and the available information available to any user may be tailored to the individual or type of employee.

It should be noted that the functions shown in FIG. 2 may be performed by one or more processors. Throughout this disclosure, the term “processing unit” is meant to denote any computational device or devices which are able to perform the functions enumerated herein. For example, in some embodiments, all of the software modules shown in FIG. 2 are performed by a single processor. In other embodiments, these modules may be executed by separate processors, which communicate required information to one another using an inter-processor communication path, such as a shared memory, communications channel, register store or other mechanism. For example, the processing unit can reside in any physical location, such as in a corporate data center, on a remote server, on a local PC, or on a combination of these and any other available technologies.

The notification mechanism of the notification module 260 may be implemented in a variety of ways. In one embodiment, one or more label printers are used to direct the activities within the deli section. The label printer may be used to notify an associate to retrieve a sliced product from an automated slicer, or to perform another task, thereby assisting with the management of work flow. This may be particularly useful in systems in which the slicer does not automatically wrap and label the order. The system may contain one or more central label printers. One or more associates are responsible for using the labeler in conjunction with fulfilling orders. In use, the associate takes the first printed label and prepares the designated order item for delivery. Following are examples of labels and actions:

For sliced product items, the label will contain all information desired, which may include the food item, quantity, alternative ordering information, traceability information, recipes, delivery location, etc. In addition, the label may contain the identification of the automated slicer that has already sliced and weighed the item, as well as an identifier linking it to a particular customer or order. The associate takes the label, goes to the identified slicer, removes the sliced product, then wraps it, places the label on it and then delivers it to the customer, or places it with other items grouped in the order. In some embodiments, the label is printed after the food item has already been sliced and therefore, the weight of the food item is known and can be printed on the label. In other embodiments, the label may be printed before the food item is sliced and a supplemental label will be required, which includes the exact weight. In some other embodiments, the slicer may have a scale that it uses to determine when the order is complete, but a second scale is used to provide the “official” weight to the consumer. In this case, a supplemental label may be produced with this “official” weight.

For orders of salads or other prepared foods, the label will contain information as above, but will direct the associate to fulfill a prepared food order, for example, 1 pint of potato salad. The associate takes the label, gets the desired food item, weighs, wraps and labels it, then delivers or places the item with others in its order.

In some cases, the food product on a slicer may be nearing its end, or a needed food product is not loaded onto a slicer. In other embodiments, an automated slicer may not be used. In this scenario, the system may print a label prompting an associate to prepare and load a needed food product into a product holder, and/or place the holder onto a slicer. In some embodiments, the label may include an RFID, bar code or other identifier means. In this manner, the label can be used by the slicing apparatus to automatically identify the food product.

This labeling system can be used to manage the fulfillment of orders. In this way, the present invention can control the order from input to delivery. Individual item orders are dispatched to the correct slicer in accordance with the queue manager 295. When slicing of a particular item is completed, the label is printed. If a prepared food item is needed with an order, the label prints, prompting the associate. In addition, the information printed on the label that the customer takes home may be used for other purposes. For example, the customer can look up detailed product information, trace the origin and supply chain of the food, etc.

In use, the associate goes to the printer, takes the next label in sequence, performs the task associated with the label, delivers the food item, then returns to the labeler and takes the next label in sequence. The timing and grouping of orders is controlled by the system to insure that orders are complete and fulfilled in the proper time and sequence.

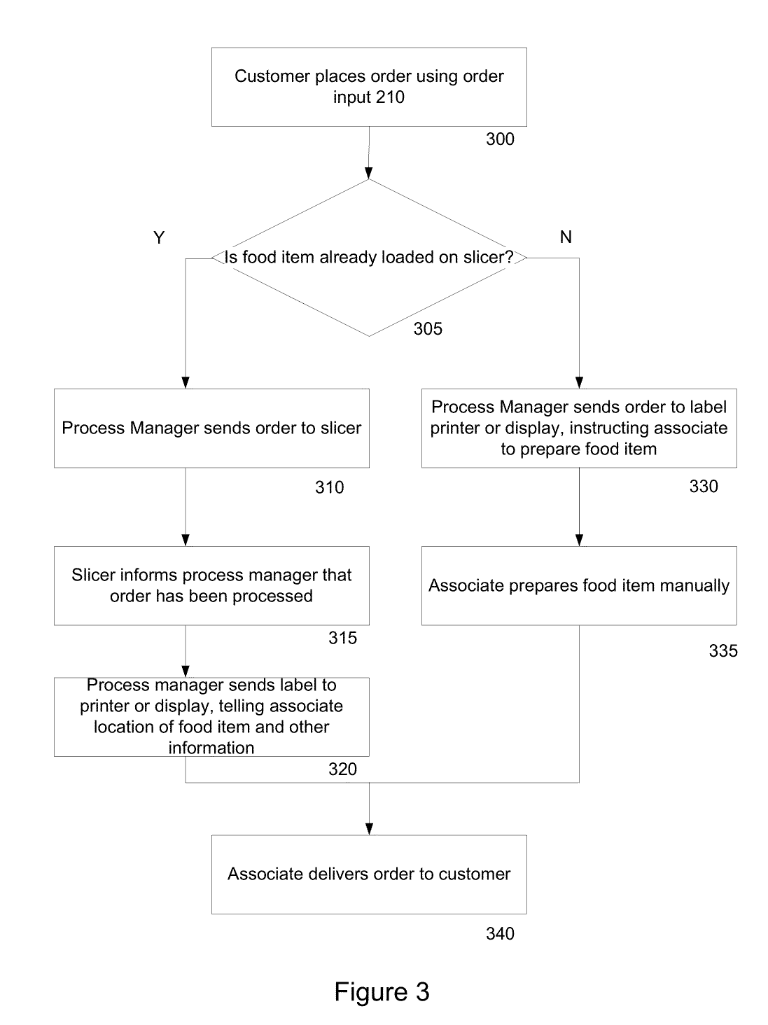

FIG. 3 shows a representative flowchart of this operation. In step 300, the customer enters an order. In this example, the order is assumed to be a single food item, but the invention is not limited to this embodiment. In the case of multiple food items on a single order, the steps of this flow are repeated, either in parallel or sequentially.

The process manager 230 checks the food item that is part of the order and determines, based on the enumeration manager 220, whether the desired food item is already located on a slicer, as seen in step 305. If the food item is located on a slicer, the process manager 220 will send the order to the appropriate slicer, as shown in step 310. When the slicer has completed the slicing operation, it will notify the process manager 230, as shown in step 315. The process manager 230 will then send a label to the printer. This label may have the identity of the food item, its quantity and an indication of which slicer prepared this food item, as shown in step 320. The associate then goes to the indicated slicer, wraps the previously sliced food item, and delivers it to the customer, or to a designated pickup area, as shown in step 340. In some embodiments, the slicer includes a certified scale. In this case, the label may be printed with the correct weight and price. If the slicer does not include a certified scale, a supplemental label may be printed after the food item is weighed on a certified scale. In the case where multiple food items are part of a single order, the associate may collect all of the food items before delivering any to the customer, or may deliver them as they are ready.

Returning to step 305, if the process manager 230 determines that the food item is not on a slicer, it sends the order to the label printer as shown in step 330. This may occur if the ordered food item is a little used product, or if the food item was a prepared food, typically bought at the deli counter, such as egg salad, macaroni salad or other such foods. In this case, the associate obtains the label from the printer, which instructs him of the desired food item and its quantity. The associate then manually prepares the requested food item, as shown in step 335. After manually preparing the requested food item, a supplemental label is printed, indicating the actual weight of the food item. As before, after it is prepared, the associate delivers the food item to the customer or to a designated pickup area, as shown in step 340.

Other activities may also be prompted by the label printer as desired. These may include sanitizing or maintenance chores, disposition of an expired food product, price reductions, communication of associate breaks, or anything else that requires communication. In fact, any function performed by the notification module 260 can be performed using a printer. In some embodiments, a printer may be associated with each automated slicer. In other embodiments, a single central printer is used, which also serves to provide guidance regarding the workflow within the deli.

In some embodiments, notifications can be accomplished with the use of a video display, such a digital display monitor, rather than using the label printer for notification. One or more displays may be located so as to be easily visible to associates. These displays comprise an “order board” that can keep track of order items, orders by customer, and any other relevant information. This seamlessly integrates the orders fulfilled both manually and automatically, resulting in efficient handling of the coordination of manual and automatic orders.

The order board tracks all orders, and notifies workers of when to pick up samples, replace food product and pick-up completed orders. It also notifies associates to manually fulfill orders, deliver completed orders to customers, perform maintenance tasks, or any other necessary communication.

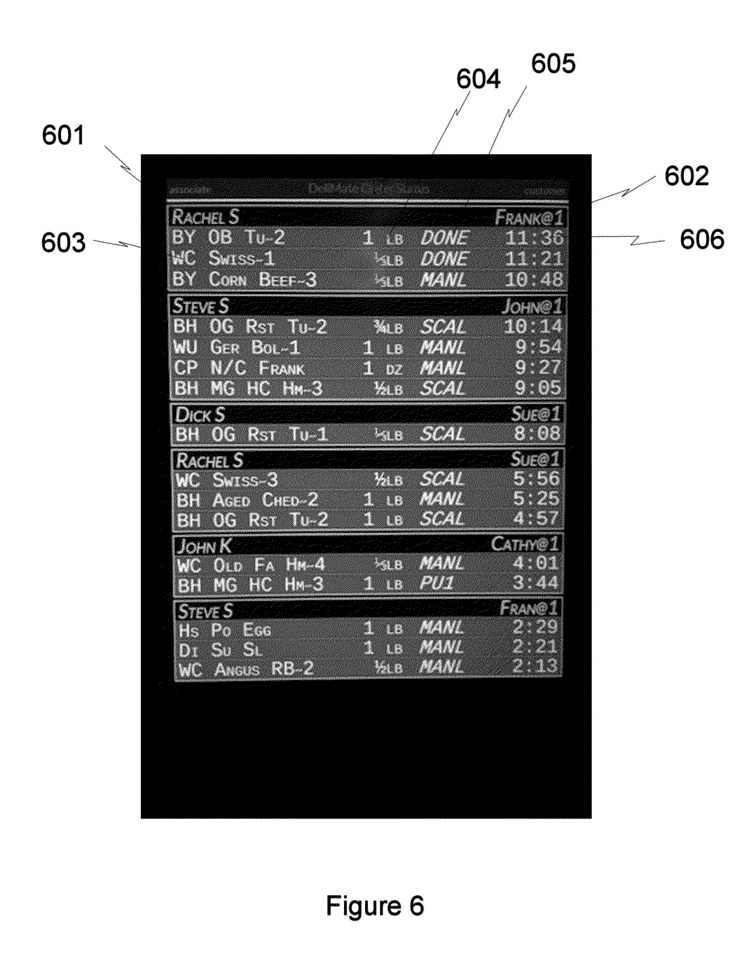

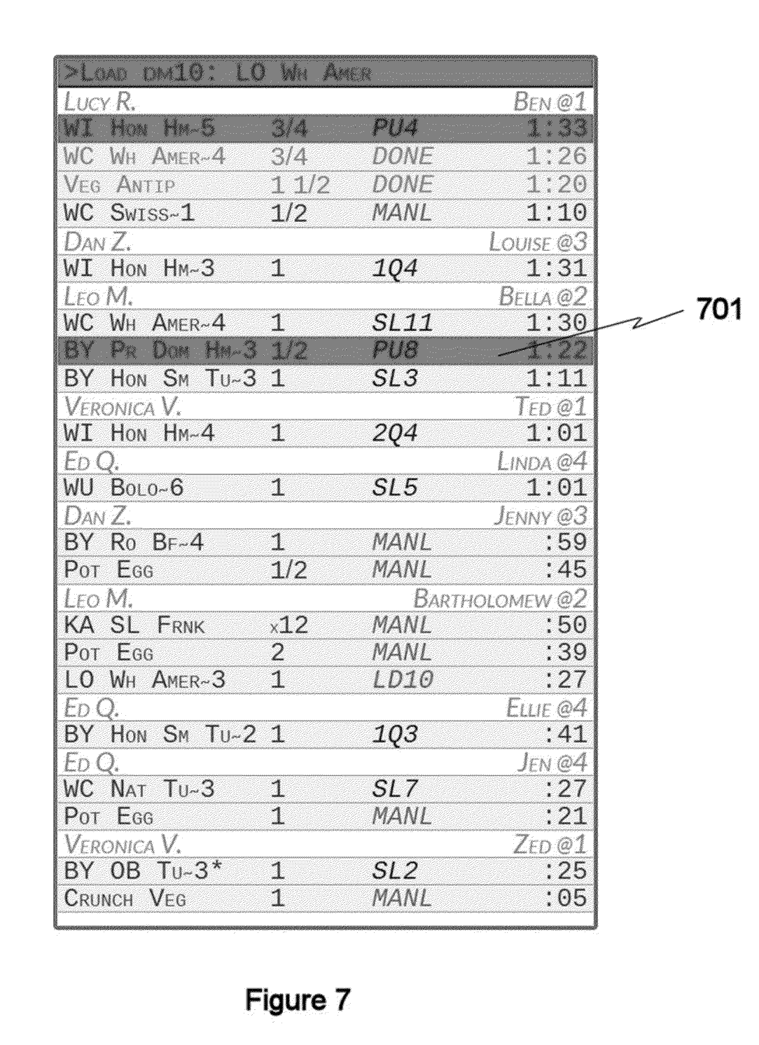

FIGS. 6 and 7 show examples of order board screens. In these examples can be seen the associate identifier 601, the customer identifier 602, the ordered product 603, the quantity ordered 604, the status of the order 605 and the time elapsed since the customer placed the order 606. For example, in FIG. 6, “MANL” indicates that the order must be performed manually; “PU1” indicates that the order is ready to be picked up from slicer 1. In FIG. 7, more detail is provided. For example “PU4” indicates that order is ready to pick up from slicer 4. The designation “1Q4” and “2Q4” indicate that these orders are first and second, respectively, in the queue for slicer 4. The designation “SL2” indicates that the order is currently being sliced on slicer 2. The customer identifier 602 may be a name, a number or some other indicia. Similarly, the associate identifier 601 may be a name, a number or some other indicia. These are just examples of the type of information that may be displayed. There may also be methods of prioritizing the activities. For example, the most urgent activities may be highlighted 701, the most immediate needs may be moved to the top of the display, etc.

Thus, the output device used by the notification module 260 is not limited by the present invention. In some embodiments, it is a digital display unit or a screen. In other embodiments, a ticket or label is generated by a printer which is in communication with the notification module 260. In these embodiments, the digital display unit, and the ticket or label, are considered to be visual indicators, which the operator can look at in order to perform the required tasks. In some embodiments, the digital display unit may be continuously updated, such that status 605 changes, new entries are added, and completed entries are removed.

Labeling the orders is a necessary function even in embodiments that do not utilize the labeler as the notification system. For automatic slicers that include a certified trade scale, labels may be automatically generated either by a centralized label printer or ones that are localized at the slicers. All other orders may be weighed and labeled in a conventional manner on a certified scale.

In some embodiments, a tray, slip paper or other packaging material is used to collect the product as it is sliced. This can be any material that is placed on the slicer's scale onto which the product falls as it is sliced. This material may have a bar code, RFID or other recognition method to uniquely identify it both at the slicer and at the certified scale. This assures that the sliced product does not get misidentified as it is transported from the slicer to the scale. Alternatively, the slicer may have a printer or other marking device that puts a unique identifier onto the packaging material at the time of slicing. This identifier may be recognized by the certified scale to positively associate the sliced product with the correct pricing and labeling information. This system assures that the product that is sliced is labeled and priced correctly and delivered to the correct customer. The above are examples of an identification system. Any technology capable of uniquely identifying the product at the slicer and the certified scale may be used.

Some embodiments can make use of the display that is included on a certified weigh scale as a select screen. When the system detects the removal of an item from the slicer, it may be added to the screen on the slicer so the operator may select it from a very limited list. This can be used for automatic slicers that utilize scales that are not certified for trade use. This may also be used for manually produced orders, which can be added to the select screen when entered into the order queue.

Communication technologies are not limited to those discussed here, and any suitable technology may be employed. Some examples are audio headsets, individual displays such as wrist mounted or eyeglasses mounted video display, smart phones etc. As new technologies emerge, they may be utilized within this system.

In addition to the software functionality described above, the present invention may also include a system which includes a food holder for holding the food items. The present invention may have the ability to trace these food items and the food holders.

In some embodiments, the food items are placed in a food holder prior to being placed on the slicer. This food holder may have several functions. First, it may serve as the container for the food item. Today, most food items in a deli are wrapped in plastic after opening. This food holder takes the place of the traditional plastic wrapping. Secondly, the food holder may have the ability to be tracked. This may be accomplished in a number of ways. For example, the food holder may have an embedded RFID tag, bar code, or other form of unique indicia. In some embodiments, the label printed by the label printer contains the unique identifier, and is placed on the holder when the food product is loaded.

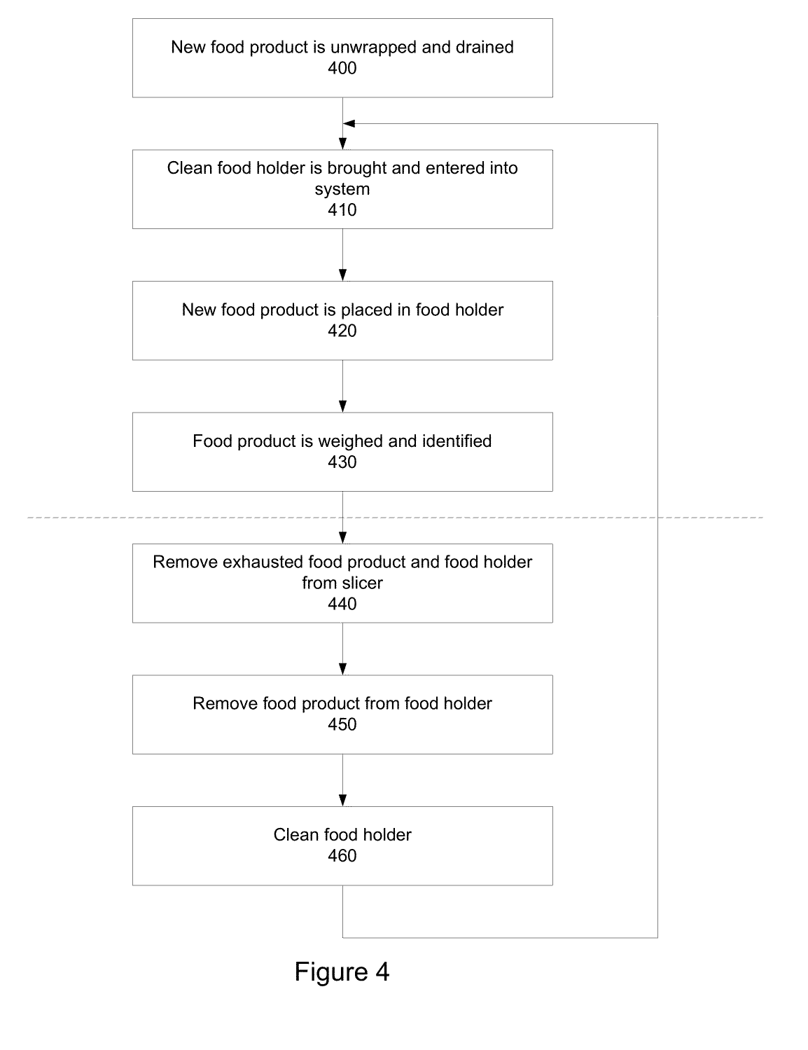

These food holders may be part of a usage cycle, as shown in FIG. 4. A clean food holder is selected to hold a new food item. Some embodiments of the current invention make use of a Prep Station to prepare food products for slicing. In particular, new, unsliced food products must be retrieved from storage, the protective wrap is removed, any liquids inside the wrapping are drained, and the product is loaded onto a product holder to be placed onto a slicer. Additionally, the product's identity may be keyed to the product holder so that the slicer can determine the food item by reading information from its food holder.

In general, the Prep Station 502 may include any or all of the following components: an unwrapping station with a sink or drain; a scale; an RFID reader or other identification recognition device; and an input/output device electronically connected to the process manager 230.

The purpose of the Prep Station 502 is to facilitate the loading of a food product into a product holder, which can then be recognized by a slicer, preferably any slicer in the system. In order to do this, the product holder may be identifiable by the slicer and the system. One method includes installing an RFID tag on the holder with a unique identifier. Other methods, such as bar codes or other electronic identifiers may also be used.

In operation, a new food product is selected and brought to the Prep Station 502, as shown in step 400. An empty product holder is placed on the station where its identifier can be read by the RFID or other reader that is part of the prep station, as shown in step 410. The system identifies the food holder and can verify that it has been cleaned and sanitized (as described below). In some embodiments, the system may not know the status of the food holder and may prompt the associate to check that the holder has been cleaned and respond to the system that it has.

As described above, the food product is unwrapped, and drained if necessary. It is then placed into the holder, as shown in step 420. In one embodiment, the associate may place the now loaded holder onto a scale to obtain its starting weight. In some embodiments, the associate enters information regarding the contents of the food holder. This may be done using a keyboard, or may be menu driven if desired. In a menu driven system, the associate simply follows the prompts on the display. This can include a menu system where the associate may select a button that corresponds to the specific food product, for example, “Boar's Head Honey Ham.” Once step 430 is complete, the system has now logged the starting weight of the product, the identity of its holder and an expiration date if applicable.

Later, when the food holder is placed onto an automated slicer, a reader contained in the slicer may identify the holder and the product contained therein. The slicer may then relay this information to the enumeration manager 220. In this way, the system can now keep track of the food product, and how much has been sold.

Using the starting weight and the subsequent sales, the system can track the remaining weight of the food item. This allows the system to predictively know when the food item is nearly exhausted.

Furthermore, through the use of RFID or other identifying indicia, the product and food holder can be removed from the slicer, and can be subsequently replaced on any slicer, which will identify it and the system will know the new location.

In another embodiment, a label has been printed, as described above, that has prompted the associate to load a particular food product. The label may contain an RFID code, a bar code or other identifying device. The label can be placed onto the product holder containing the food product. The Prep Station scans the identifier, which automatically loads the product information into the system. In some embodiments, this identifier becomes the only indicia that are read by the slicer, eliminating the need to have RFID tags or other devices on the product holders themselves.

The preceding steps 400-430 are used to check the food product into the system where it can be followed until it is sold, reaches its expiration date, or is removed for another reason. At this point, the food product and holder must be checked out of the system. As delineated by the dashed line in FIG. 4, the steps above the line relate to checking the food product into the system, and the steps below the line relate to checking the food item out of the system.

The food item is then returned to the Prep Station 502 where it is optionally re-weighed, the food holder is then disassociated with the food item as shown in step 450, and is checked out and identified as dirty. The remainder of the food product is disposed of, used to make salads, or used for another purpose. The information that the system has gathered, such as starting weight, ending weight, disposition, cleaning and sanitation, etc., can be used by the system for inventory, reporting, traceability or other purposes.

The food holder is then washed or otherwise sanitized, as shown in step 460. In some embodiments, the food holder is manually cleaned. After cleaning the associate may place the food holder on the Prep Station 502 to identify it as clean.

In other embodiments, a warewasher 503 may be used. The warewasher may be basically an industrial dishwasher and helps to assure cleanliness and sanitation. This can be a general apparatus, or a purpose-built machine that cleans product holders, slicer blades and platforms, and other items used in the preparation and sale of food. In some embodiments, the warewasher includes a device to read RFID or other identifying tags that can be located on items to be cleaned. In this embodiment, a reader in the warewasher identifies the holder and informs the system that it has been cleaned. Once the system has identified the food holder and insured its cleanliness, a new product can be loaded, as shown in step 410.

In some embodiments, the food product holder is an integral part of the slicer, and the food product is placed directly onto the slicer. In this case, a new food product is unwrapped and placed onto the slicer as directed by the dispatch manager 240. In some embodiments, the slicer has a provision to weigh the food product that has been placed onto it. In one example, the slicer may have load cells built into its feet that can be used to weigh the entire slicing apparatus. Before the food product is placed onto the slicer, the load cells measure the weight of the slicer without the food product to determine the tare weight. The food product is now placed onto the slicer, the load cells take another measurement, and the difference between this measurement and the tare is the weight of the food product. Alternatively, a food product can be weighed separately prior to placing it onto the slicer, and this weight can be entered manually into the system.

This process allows tracing and documenting of the cleaning and sanitizing processes.

The present invention insures cleanliness and sanitation by monitoring and enforcing sanitation protocols. These protocols may be programmed into the system, and include sanitation compliance monitoring, either by interaction with associates or direct monitoring of electronically identifiable devices such as product holders; prompting of associates to perform cleaning and sanitizing of equipment, floors and surfaces; scheduling of sanitation maintenance, and logging and maintaining sanitation information. The system can also oversee produce conditioning, produce misting, or anything else that requires cleaning and/or sanitation.

Another advantage of the present invention is its ability to track food products from receipt into the store to delivery to the customer. Food products generally are marked with lot numbers that can identify when and where they were produced. In a current delicatessen, this lot number is generally lost when an individual food product is unwrapped, and certainly cannot be followed once an item is sliced and delivered to a customer.

The current system can log the product information at the Prep Station, receiving dock, etc., and then track its location status, i.e. on a slicer, in the cooler, etc. It then can log out the product as sliced and sold, or returned to the Prep station for disposal, or reuse.

In other words, information into the system can include food item description and lot code, expiration date, physical location, etc., while the information retrieved from the system may include usage reports, shrink information, inventory information, expiration dates, expiration alerts for disposal, dates and customers of sales.

The present invention can also supply labeling information, including lot codes, use-by dates, and any other information desired.

In the event of a product recall, the system may issue a recall alert. A distinct advantage of this system is the ability to contact customers who have purchased a recalled product. Any customer who has used a loyalty card or other identifying mechanism while purchasing the recalled food item can be notified directly if there is a recall or other product safety concern.

In some embodiment, the present invention can monitor the temperature of cases, coolers and freezers, and may extend to individual food items if infrared or other devices are employed. This information can be used to insure that perishable foods are maintained at the correct temperature. Keeping these items at the correct temperature will minimize spoilage and the possibility of selling spoiled food. The system can also be used to alert management or repair persons that the temperatures are beginning to rise in a particular location, and predictively repair a problem rather than wait for a failure.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. An automated custom food preparation system, comprising:
a plurality of automated slicing apparatus;
an output device; and
a computer system, comprising
an order input module for accepting orders from a customer, a dispatch manager for instructing one of said automated slicing apparatus to slice said order; and
a notification module in communication with said output device to notify an operator as to the identity of said automated slicing apparatus that is slicing said order.

2. The automated custom food preparation system of claim 1, wherein said output device comprises a visual indicator on which said order and said automated slicing apparatus slicing said order is shown.

3. The automated custom food preparation system of claim 2, wherein said visual indicator shows orders which cannot be automatically performed by any of said plurality of automated slicing apparatus.

4. The automated custom food preparation system of claim 3, wherein said visual indicator shows a customer identifier for said order.

5. The automated custom food preparation system of claim 3, further comprising at least one manual slicing apparatus, wherein an operator uses said manual slicing apparatus for orders which cannot be automatically performed by any of said plurality of automated slicing apparatus.

6. The automated custom food preparation system of claim 2, wherein said visual indicator shows the status of said order on said automated slicing apparatus.

7. The automated custom food preparation system of claim 3, wherein said computer system is aware of the food item loaded on each of said automated slicing apparatus.

8. The automated custom food preparation system of claim 7, wherein said computer system informs an operator as to which food item is be placed on each of said plurality of automated slicing apparatus.

9. The automated custom food preparation system of claim 7, wherein said automated slicing apparatus has an input device, wherein it is made aware of the identity of a food item placed thereon, and said automated slicing apparatus reports said identity to said computer system.

10. An automated custom food preparation method, comprising:
entering a customer's order into a computer, said computer in communication with a plurality of automated slicing apparatus and an output device;
slicing at least part of said customer's order on one of said plurality of automated slicing apparatus; and
notifying an operator using said output device of an identity of said one of said plurality of automated slicing apparatus.

11. The automated custom food preparation method of claim 10, further comprising notifying said operator that a part of said customer's order cannot be fulfilled using any of said plurality of automated slicing apparatus.

12. The automated custom food preparation method of claim 10, further comprising notifying said operator of a status of said customer's order.

13. The automated custom food preparation method of claim 10, wherein said customer enters said order via an input device.

14. The automated custom food preparation method of claim 10, wherein said operator enters said customer's order via an input device.

15. An automated process of creating pre-packaged food items, comprising:
using an automated slicing apparatus to slice said pre-packaged food item;
estimating consumption of said pre-packaged food item; and
slicing additional pre-packaged food items based on said estimated consumption using said automated slicing apparatus.

16. The automated process of creating pre-packaged food items of claim 15, wherein said estimating comprises monitoring sales of said pre-packaged food item.

17. The automated process of creating pre-packaged food items of claim 15, wherein said estimating comprises monitoring a display case containing said pre-packaged food item.

18. The automated process of creating pre-packaged food items of claim 15, wherein said estimating comprises monitoring waste associated with said pre-packaged food item.

19. The automated process of creating pre-packaged food items of claim 15, wherein said estimating comprises using historical data to estimate future requirements.
